(19) United States
(12) Patent Application Publication
(10) Pub. No.: US 2018/0106323 A1
(43) Pub. Date: Apr. 19, 2018

(54) INSTRUMENTED FLEXIBLE LOAD BEARING CONNECTOR

(71) Applicant: LORD Corporation, Cary, NC (US)

(72) Inventors: Charles J. ALLRED, Shelburne, VT (US); Matthew A. SMITH, Erie, PA (US)

(21) Appl. No.: 15/567,761

(22) PCT Filed: May 4, 2016
(86) PCT No.: PCT/US2016/030781

§ 371 Date: Oct. 19, 2017

Related U.S. Application Data
(60) Provisional application No. 62/156,465, filed on May 4, 2015.

(51) Int. Cl. F16F 1/41; G01L 5/00; B64C 27/35; E21B 33/038; B64D 45/00

(52) U.S. Cl. CPC F16F 1/41; G01L 5/0009; G01L 5/0033; E01D 19/041; E21B 33/038; B64D 45/00; B64D 2045/0085; B64C 27/35

(57) ABSTRACT

This application provides for flexible load bearing connectors (FLBCs) systems and methods and for monitoring, reporting, and responding to the performance and/or health of the FLBC. The system provided is an instrumented FLBC that can at least one of sense, record, report, react to and/or otherwise make use of performance and/or health information of the FLBC. The performance and/or health information can include any information related to movement (such as displacements and/or relative motions) of the FLBC and/or the system components the FLBC joins together and/or loads, vibrations, shocks, and environmental exposures the FLBC receives, transmits, supports, and/or experiences.

### CROSS-REFERENCE TO RELATED APPLICATIONS

The present application claims the benefit of U.S. Provisional Patent Application Ser. No. 62/156,465, filed May 4, 2015, the disclosure of which is incorporated herein by reference in its entirety.

### FIELD OF THE INVENTION

Embodiments described herein relate to systems and methods of providing and monitoring flexible load bearing connections.

### BACKGROUND

Some architectural, structural, agriculture, shipping, transportation, energy production, and military systems include flexible load bearing connectors, such as, but not limited to, high capacity laminate (HCL) bearings. Some flexible load bearing connectors can receive, transmit, and/or support very high loads, such as, but not limited to, a portion of the weight of one or more of the above-described systems while also allowing and/or limiting a predetermined range of relative motion between system components. Some flexible load bearing connectors can also receive and/or transmit shocks and vibrations, such as, but not limited to, shocks and vibrations resulting from ocean wave, seismic wave, automobile traffic, or other shock or vibration source.

### SUMMARY

In one aspect, a system is provided. The system comprises a first a first component, a second component, a bearing stack and at least one of a sensor, a communication device or a processor. The bearing stack is disposed between the first component and the second component. The bearing stack including at least two stacked elastomeric elements and at least one non-elastomeric element disposed between the at least two stacked elastomeric elements. The at least one of a sensor, a communication device, or a processor is at least partially disposed within the bearing stack. Wherein the bearing stack is configured to support at least about 500 kilopounds.

In another aspect, a system is provided. The system comprises a first component, a second component, a bearing stack, and at least one of a sensor, a communication device, and/or a processor. The bearing stack is disposed between the first component and the second component. The bearing stack including at least two stacked elastomeric elements and at least one non-elastomeric element disposed between the at least two stacked elastomeric elements. The at least one of a sensor, a communication device, and/or a processor is at least partially disposed at least one of the first component and the second component.

In yet another aspect, a system is provided. The system comprises a first component, a second component, a bearing stack, and at least one of a sensor, a communication device, and/or a processor. The bearing stack is disposed between the first component and the second component. The bearing stack including at least two stacked elastomeric elements and at least one non-elastomeric element disposed between the at least two stacked elastomeric elements. The at least one of a sensor, a communication device, and/or a processor is at least partially disposed within at least one of the first component and the second component. Wherein the bearing stack is configured to support a primary centrifugal force generated during rotation of the bearing stack about a mast of a helicopter.

### BRIEF DESCRIPTION OF THE DRAWINGS

FIG. 1 is a schematic view of a physical system that includes a flexible load bearing connector (FLBC) or motion control bearing.

FIG. 2 illustrates a flow diagram of a wireless sensor for a motion control bearing.

FIGS. 3-5 illustrate some exemplary placement of sensors in an elastomeric device.

FIG. 6 illustrates an exemplary kinetic energy power harvester.

FIG. 7 illustrates an exploded view of the kinetic energy power harvester without an elastomeric element.

FIG. 8 illustrates a bottom view of the kinetic energy power harvester without an elastomeric element, including the winding and plurality of magnets.

FIG. 9 illustrates a sectional side view of the kinetic energy power harvester without the elastomeric element, including the winding.

FIG. 10 illustrates a perspective sectional side view of the kinetic energy power harvester without the elastomeric element, including the plurality of magnets.

FIG. 11 illustrates a perspective side view of an embodiment of an energy harvesting load sensing assembly.

FIG. 12 illustrates a perspective exploded view of the energy harvesting load sensing assembly.

FIG. 13 illustrates the magnetic field associated with the motion control bearing.

FIG. 14 illustrates a longitudinally extending linear displacement sensor assembly.

FIG. 15 illustrates a schematic placement of multiple sensors.

FIG. 16 illustrates a schematic placement of multiple sensors.

FIG. 17 illustrates use of a magnetometer for motion sensing.

FIG. 18 illustrates use of a linear displacement sensor for motion sensing.

FIG. 19 illustrates test results.

FIG. 20 illustrates an inertial sensing approach for motion sensing.

FIG. 21 illustrates a bridge system including a FLBC.

FIG. 22 illustrates a building system including a FLBC.

FIG. 23 illustrates a riser system including a FLBC.

FIG. 24 illustrates a tendon riser bearing system including an FLBC.

### DETAILED DESCRIPTION

This application discloses systems and methods for not only providing flexible load bearing connectors (FLBCs) but also monitoring, reporting, and responding to the performance and/or health of the FLBC. In some architectural, structural, agriculture, shipping, transportation, energy production, and military systems that include FLBCs, the remainder of the architectural, structural, agriculture, shipping, transportation, energy production, and military systems can generate and/or receive cyclic and/or intermittent forces, vibrations, and/or displacements and/or relative motions that are received and/or supported by a FLBC and/or transmitted via an FLBC. The forces and/or vibrations can result in movement of the FLBC and/or the system components joined together by the FLBC. In some embodiments, the systems and methods disclosed herein comprise an instrumented FLBC that can at least one of sense, record, report, react to and/or otherwise make use of performance and/or health information of the FLBC. The performance and/or health information can include any information related to movement (such as displacements and/or relative motions) of the FLBC and/or the system components the FLBC joins together and/or loads, vibrations, shocks, and environmental exposures the FLBC receives, transmits, supports, and/or experiences. This disclosure contemplates systems and methods of achieving at least one of the above-described sensing, recording, reporting, and reacting to performance and/or health information of the FLBC by utilizing at least one component carried on and/or within the FLBC, such as, but not limited to, a sensor, a processor, a chemical reactant, a communication device, and or any other suitable component configured for integration into an FLBC and/or attachment to an FLBC. An FLBC can comprise a bearing stack comprising layers of elastomeric elements and non-elastomeric elements or shims Accordingly, a physical system 1000 is disclosed below that can be operated according to a variety of methods and embodiments described herein.

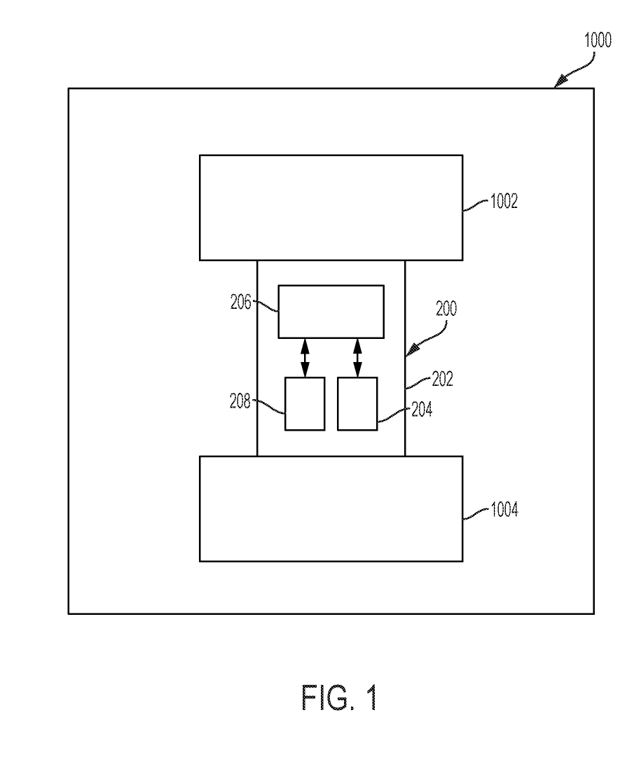

Referring to FIG. 1, a physical system 1000 is shown. The system 1000 comprises a first component 1002 and a second component 1004 flexibly coupled together using a FLBC 200. In this embodiment, FLBC 200 includes a high capacity laminate (HCL) bearing that includes a sensor 202, a processor 204, and a communication device 206. In this embodiment, at least one of the sensor 202, processor 204, and communication device 206 is at least partially housed within a recess or void of a composite laminate stack or bearing stack of the HCL bearing so that the FLBC 200 is instrumented and carries at least one component configured to support sensing, recording, reporting, reacting to, and/or otherwise making use of performance and/or health information of the FLBC 200. The FLBC 200 can be configured as a motion control bearing attached between the first component 1002 and the second component 1004 while transmitting and/or supporting a significant load, such as, but not limited to, a load on the order of hundreds of kilopounds between the first component 1002 and the second component 1004. In some cases, the primary source of the very large load may be attributable to gravitational forces acting on the components of the physical system 1000 itself so that a primary force vector is substantially directed downward. In some embodiments, the FLBC 200 includes at least one power source for powering at least one of the sensor 202, the processor 204, and the communication device 206. The power source can be integrated with or separate from the one or more of the sensor 202, the processor 204, and the communication device 206.

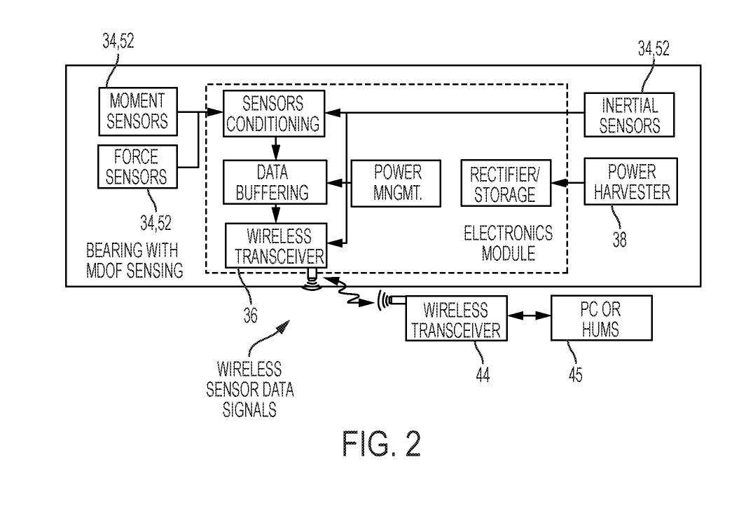

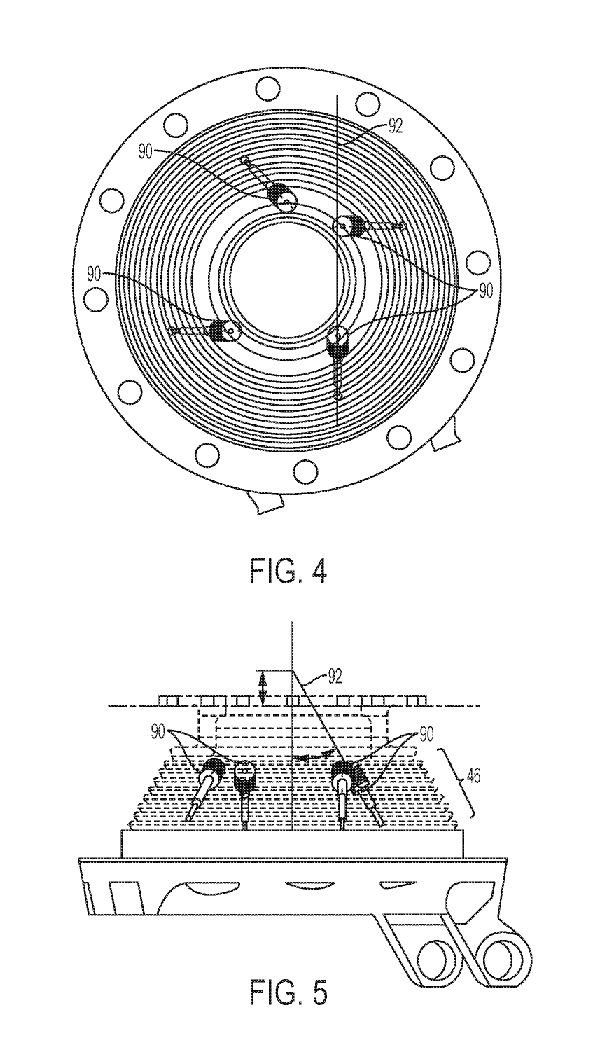

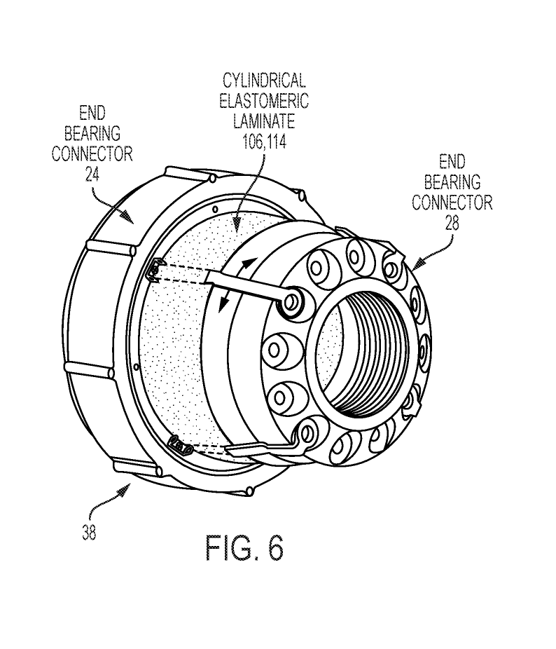

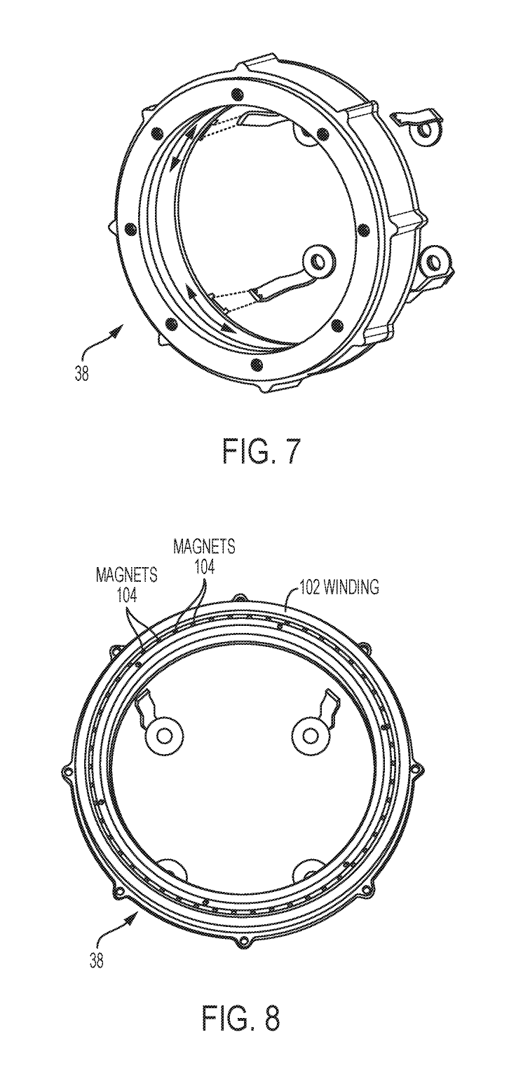

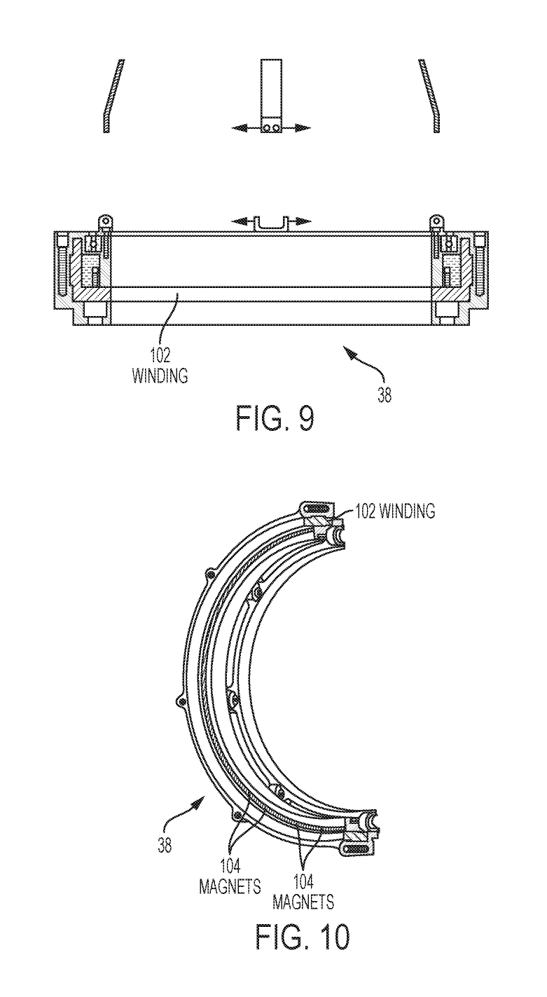

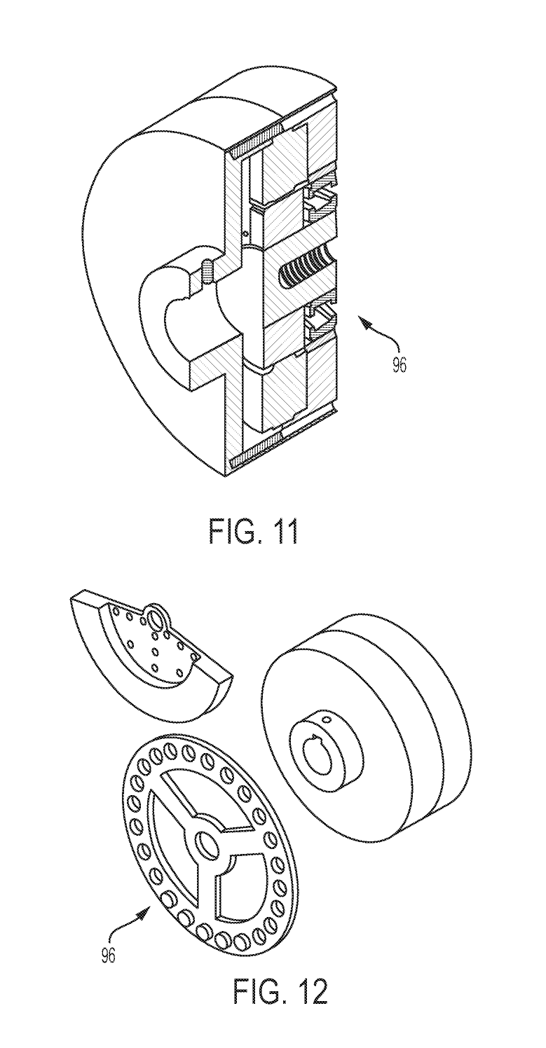

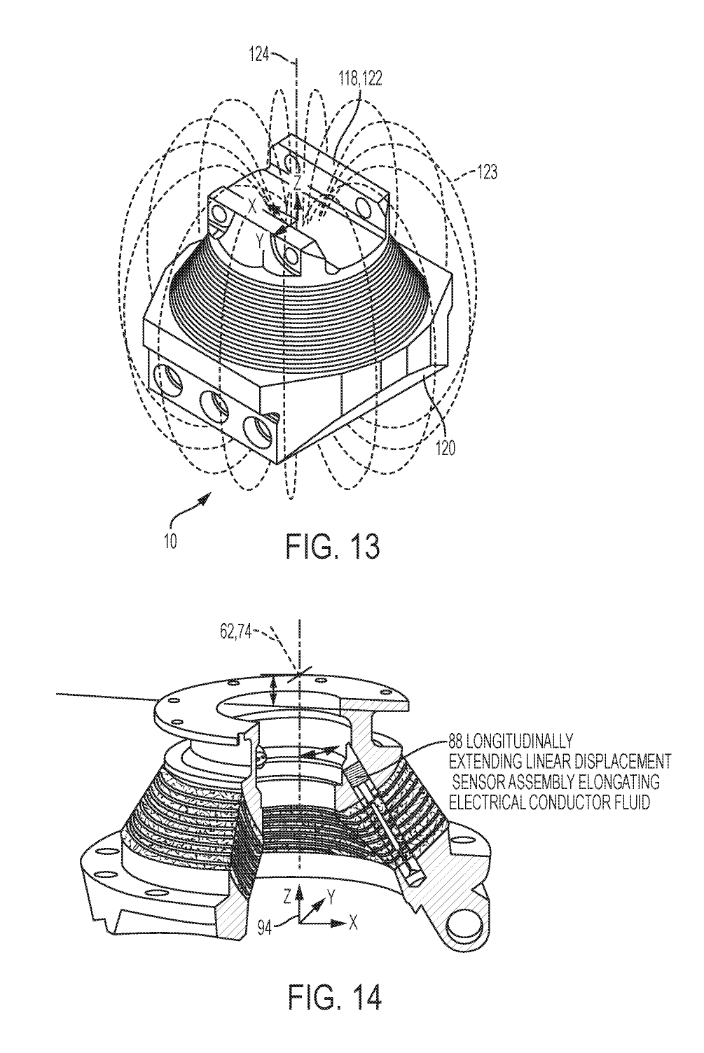

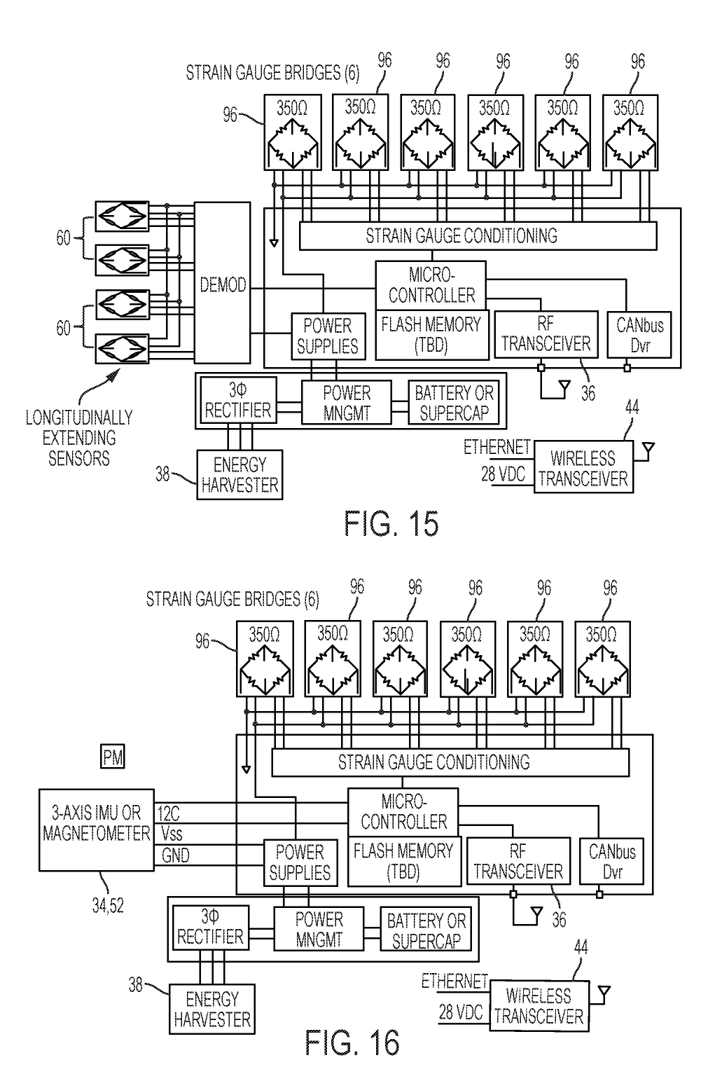

Referring now to FIGS. 2-16 a FLBC or motion control bearing device 10 and related components are shown. The bearing device 10 includes at least a first sensor member 34, the first sensor member 34 coupled with the first end bearing connector 24. The first sensor member 34 senses a movement between the first end bearing connector 24 and a second end bearing connector 28. The bearing device 10 includes a second sensor member 52, the second sensor member 52 coupled with the first end bearing connector 24. In one embodiment the first and second sensor members 34, 52 oriented and coupled on the bearing device 10 are oriented accelerometers and gyroscopes, with the accelerometers oriented relative to the dominant acceleration vector, such as gravity. The accelerometers are oriented relative to the bearing center of rotation 58.

In this embodiment, the coupling or bearing device 10 first sensor member 34 is comprised of a longitudinally extending sensor 60 extending along a longitudinal sensor axis 62 from a first sensor end 64 to a distal second end 66. As illustrated, the longitudinally extending sensor 60 distal second end 66 is coupled with the second end bearing connector 28. In this embodiment the longitudinally extending sensor 60 is a linear variable differential transformer. The longitudinally extending sensor 60 is configured to detect a targeted detected section of the second end bearing connector 28, in some embodiments, with the longitudinally extending sensor 60 comprised of a non-contact variable differential transformer 70. The longitudinally extending sensor 60 distal second end 66 is coupled with the second end bearing connector 28 and is, in some cases, configured as a complementing sensor member pair end 72 to the first sensor member 34 first sensor end 64. The complementing sensor member pair ends 72 sensing a position characteristic between the first end bearing connector 24 and the second end bearing connector 28 along a longitudinally extending axis 74. The longitudinal sensor axis 62 is aligned with the longitudinally extending axis 74, a longitudinally extending linear displacement sensor assembly 78, a longitudinally extending variable reluctance transducer sensor assembly, and a longitudinally extending differential variable reluctance transducer sensor assembly. As illustrated, the longitudinally extending sensor 60 is comprised of a longitudinally extending linear displacement sensor assembly 78. In some embodiments the longitudinally extending sensor 60 is a displacement transducer having axial displacement between conductive surfaces changes the space between the conductive surfaces with a sensed electrical change providing sensor data relative to the displacement between the end bearing connector 24, 28.

In an embodiment the longitudinally extending linear displacement sensor assembly 78 includes an elongating electrical conductor. In some embodiments, a longitudinally extending linear displacement sensor assembly comprises an elongating electrical conductor fluid 88 and is configured to have a change in electrical characteristic relative to elongation. In an embodiment, resistance of the electrical conductor changes with the changing displacement. In an embodiment, the elongating electrical conductor is a liquid metal mass, in some embodiments, a liquid metal mass comprised of Gallium and Indium.

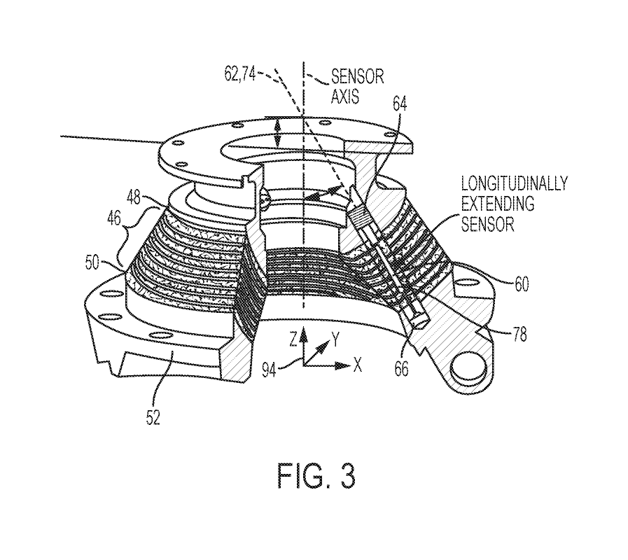

In the embodiments, the bearing device 10 includes at least one complementing pair longitudinally extending sensor member assemblies 90 sensing position characteristics between the first end bearing connector 24 and the second end bearing connector 28, in some embodiments, with their longitudinally extending sensor 60 having nonparallel axes. As illustrated, the longitudinally extending sensor member assemblies 90 extend through the spherical shell segments 46, in some embodiments, with nonparallel axis 92 oriented nonparallel to the bearing center z axis 94. FIGS. 3-5 illustrate four longitudinally extending sensor member assemblies 90 extend through the spherical shell segments 46, in some embodiments, with their longitudinally extending axis 74 nonparallel to each other.

The bearing device 10 includes a load sensing assembly 96 and, in some cases, the load sensing assembly 96 is comprised of a plurality of strain gauge bridges coupled with the first end bearing connector 24.

In some embodiments, the bearing device 10 includes a second sensor member 52, the second sensor member 52 coupled with the second end bearing connector 28. In the illustrated embodiments the bearing device 10 includes a first magnetic field sensing first sensor member 118, in some embodiments, a magnetometer 118, and the second sensor member 52 is comprised of a second magnetic sensor target 120 coupled with the second end bearing connector 28. In some embodiments, the magnetometer is a three axis magnetometer, oriented and centered on the first end bearing connector 24 longitudinally extending axis 74. The three axis magnetometer is comprised of three orthogonal vector magnetometers measuring magnetic field components including magnetic field strength, inclination and declination.

The second oriented magnetic sensor target 120 is coupled with the second end bearing connector 28. The permanent magnet target 122 is oriented and centered on the second end bearing connector 28 longitudinally extending axis 74, with the permanent magnet target 122 generating magnetic field lines 123. In an embodiment, the second end bearing connector 28 is comprised of a nonmagnetic metal, the first end bearing connector 24 is comprised of a nonmagnetic metal, and the interior nonelastomeric shims 18 are comprised of a nonmagnetic metal.

In an embodiment, the second end bearing connector 28 is comprised of a magnetic metal. In an embodiment, the first end bearing connector 24 is comprised of a magnetic metal. In an embodiment at least one of the nonelastomeric shims 18 are comprised of a magnetic metal. In some embodiments, with the oriented magnetometer and the distal permanent magnet target 122, the relative location of the sensor within the magnet's magnetic field is measured. The magnetometer readings from the three axes is filtered and processed to produce signals which are proportional to the x, y, z axis displacement between the magnet and sensor. In some embodiments, the magnetometer is oriented and centered on the central axis 124 of the spherical bearing 126, the magnetometer's three axes are oriented in relation to the magnetic field lines 123 of the permanent magnet target 122.

The bearing device 10 has an operational lifetime beginning spring rate SRB and an operational lifetime end spring rate SRE with SRE<SRB. Sensing technology is used for health monitoring and potentially control feedback. The device monitors the operational spring rate of the elastomeric laminate 16 relative to the SRB and the SRE. The sensor data is used to monitor bearing device 10 usage, monitor and collect loading history statistics experienced by the bearing, catalog usage exceedance events (bearing events that relate to bearing stress and/or strain that exceeds predefined threshold indicating significant damage, compromised bearing life, need for near-term inspection or removal/replacement, estimate remaining bearing life, monitor loading history for tracking cumulative damage). In some embodiments, the sensors are configured to monitor operational lifetime OL cycles of at least about forty five million cycles to about eighty nine million cycles.

A method for making a bearing device 10 includes providing a second sensor member 52, the second sensor member 52 coupled with the first end bearing connector 24. In preferred methods, the first and second sensors 34, 52 are accelerometers and/or inertial sensors.

The method includes the first sensor member 34 comprised of a longitudinally extending sensor 60 extending along a longitudinal sensor axis 62 from a first sensor end 64 to a distal second end 66. The longitudinally extending sensor 60 distal second end 66 is coupled with the second end bearing connector 28.

In an embodiment, the longitudinally extending sensor 60 distal second end 66 coupled with the second end bearing connector 28 is the second end bearing connector 28. In an embodiment, the longitudinally extending sensor 60 is a linear variable differential transformer. In an embodiment, the longitudinally extending sensor 60 is a non-contact variable differential transformer sensing a targeted detected section of the second end bearing connector 28.

In some embodiments, the longitudinally extending sensor 60 distal second end 66 coupled with the second end bearing connector 28 is a complementing sensor member pair end 72 to the first sensor member 34 first sensor end 64, with the complementing sensor member pair ends 72 sensing a position characteristic between the first end bearing connector 24 and the second end bearing connector 28, in some cases, along a longitudinally extending axis 74 with the longitudinal sensor axis 62 aligned with the longitudinally extending axis 74. The sensor assembly comprises a longitudinally extending linear displacement sensor assembly 78, a longitudinally extending variable reluctance transducer sensor assembly, and a longitudinally extending differential variable reluctance transducer sensor assembly.

In embodiments, the sensor is a displacement transducer having axial displacement between conductive surfaces that changes the space between the conductive surfaces. A sensed electrical change provides sensor data relative to the displacement between the end bearing connector 24, 28.

In an embodiment, the sensor is a longitudinally extending linear displacement sensor assembly 78 having an elongating electrical conductor and a longitudinally extending contained elongating electrical conductor fluid 88 configured to change an electrical characteristic relative to elongation. In some embodiments, a sensed change in resistance provides a sensed change in displacement. In embodiments, the longitudinally extending contained elongating electrical conductor fluid 88 is a liquid metal mass, and in some cases, a liquid metal mass comprised of Gallium and Indium.

The method includes disposing a plurality of the complementing pair longitudinally extending sensor member assemblies 90 sensing position characteristics between the first end bearing connector 24 and the second end bearing connector 28, in some embodiments, with their longitudinally extending axis 74 nonparallel. The longitudinally extending sensor member assemblies 90 extend through the spherical shell segments 46. The four longitudinally extending sensor member assemblies 90 extend through the spherical shell segments 46, in some embodiments, with their longitudinally extending axis 74 nonparallel to each other.

The method includes providing a load sensing assembly 96. In some embodiments, the load sensing assembly 96 is comprised of a plurality of strain gauge bridges coupled with the first end bearing connector 24.

The method includes providing a second sensor member 52, the second sensor member 52 coupled with the second end bearing connector. The second sensor member 52 coupled with the second end bearing connector 28 is a magnet. In some embodiments, the bearing device 10 is provided with a first magnetic field sensing first sensor member 34, in some cases, a magnetometer, and the second sensor member 52 is comprised of a second magnetic sensor target 120 coupled with the second end bearing connector 28. In some cases, the provided magnetometer is a three axis magnetometer, oriented and centered on the first end bearing connector 24 longitudinally extending center axis 74. The three axis magnetometer is comprised of at least three orthogonal vector magnetometers measuring magnetic field components including magnetic field strength, inclination and declination. The second magnetic sensor target 120 is coupled with the second end bearing connector 28, and the permanent magnet target 122 is oriented and centered on the second end bearing connector 28 longitudinally extending axis 74, with the permanent magnet target 122 generating magnetic field lines 123.

In an embodiment the second end bearing connector 28 is comprised of a nonmagnetic metal and the first end bearing connector 24 is comprised of a nonmagnetic metal. In an embodiment, the second end bearing connector 28 is comprised of a magnetic metal. In an embodiment, the first end bearing connector 24 is comprised of a magnetic metal. In some embodiments, the magnetometer readings from the three axes are filtered and processed to produce signals which are proportional to the x, y, z axis displacement between the magnet and sensor. As illustrated the magnetometer sensor is oriented and centered on the central axis of the spherical bearing, the sensor's three axes are oriented in relation to the magnetic field lines 123 of the permanent magnet target 122.

The bearing device 10 has the operational lifetime OL with the at least first sensor member 34 monitoring an operational spring rate between the first end bearing connector nonelastomeric metal member 24 and the second end bearing connector 28. The bearing device 10 may also be configured to monitor other operational conditions in addition to or instead of a spring rate.

The bearing device 10 can provide load sensing, and provides prognostics data for the bearing device 10 provides load information for improved regime recognition, and usage information. The bearing device 10 is configured to provide load and motion sensing. In this embodiment, the sensors provide for measuring in-plane bearing measuring loads in six degrees-of-freedom. The bearing device 10 preferably provides comprehensive loads and motions data, including six degrees-of-freedom load sensing. The bearing device 10, in some cases, provides three axes of dynamic motion measurement and in some cases potentially four motion measurements (three rotational, one translational)

The bearing device 10, in some cases, includes moment sensors, such as strain gauges coupled to the spherical bearing end bearing connector member 128 and having full bridge strain gauges. The bearing device 10, in some cases, includes force sensors, such as sensors providing measurements of in-plane, vertical and centrifugal loads. Inertial Sensors, in some cases, are located proximate the bearing device electronics module 130 provide measurement of inertial motion and are configured to provide dynamic displacements in these degrees-of-freedom.

The bearing device 10 provides sensing of health through in situ dynamic stiffness measurements. The bearing device 10 provides load measurements to provide fatigue loading cycle counts and regime recognition. The bearing device 10 provides static position information. Static position is provided with the inertial sensors and strain gauges for calculating bearing dynamic stiffness. Static position is provided with an empirical model of inferring bearing static stiffness from dynamic stiffness. In some embodiments, static position is provided with calculations from the strain gauges and static stiffness. The bearing device 10 with longitudinally extending sensors 60 measures bearing motion, and the sensor data is used in combination with load sensing data, in some embodiments, from the strain gages, to provide in situ stiffness measurements. In some embodiments, the bearing device 10 with longitudinally extending sensors 60 in the spherical elastomeric laminate measures motions of the bearing, such as angular-x (lead-lag), angular-y (flap), angular-z (pitch), and z-displacement (CF).

The method includes providing a second sensor member 52. The second sensor member 52 coupled with the first end bearing connector 24, in some embodiments, with first and second oriented accelerometers.

The first sensor member 34 is comprised of a longitudinally extending sensor 60 extending along a longitudinal sensor axis 62 from a first sensor end 64 to a distal second end 66. The method includes the first sensor member 34 being comprised of a longitudinally extending sensor 60 extending along a longitudinal sensor axis 62 from a first sensor end 64 to a distal second end 66. The longitudinally extending sensor 60 distal second end 66 is coupled with the second end bearing connector 28. In an embodiment, the longitudinally extending sensor 60 distal second end 66 coupled with the second end bearing connector 28 is the second end bearing connector 28. In an embodiment, the longitudinally extending sensor 60 is a linear variable differential transformer. In an embodiment, the sensor is a non-contact variable differential transformer sensing a targeted detected section of the second end bearing connector 28.

The longitudinally extending sensor 60 distal second end 66 coupled with the second end bearing connector 28 is a complementing sensor member pair end 72 to the first sensor member 34 first sensor end 64. The complementing sensor member pair ends 72 is configured to sense a position characteristic between the first end bearing connector 24 and the second end bearing connector 28 along a longitudinally extending axis 74 with the longitudinal sensor axis 62 aligned with the longitudinally extending axis 74. In some embodiments, the sensor assembly comprises a longitudinally extending linear displacement sensor assembly 78, a longitudinally extending variable reluctance transducer sensor assembly, and a longitudinally extending differential variable reluctance transducer sensor assembly. In embodiments, the longitudinally extending sensor 60 is a displacement transducer having an axial displacement between conductive surfaces which changes the space between the conductive surfaces with a sensed electrical change providing sensor data relative to the displacement between the end bearing connector 24, 28. In embodiments, the sensor is a longitudinally extending linear displacement sensor assembly 78, having an elongating electrical conductor and a longitudinally extending contained elongating electrical conductor fluid 88 which changes an electrical characteristic relative to elongation. In some embodiments, resistance provides a sensed change in displacement. In some embodiments, the longitudinally extending contained elongating electrical conductor fluid 88 is a liquid metal mass, such as a liquid metal mass comprised of Gallium and Indium.

In some embodiments, the method includes disposing a plurality of the complementing pair longitudinally extending sensor member assemblies 90 configured to sense position characteristics between the first end bearing connector 24 and the second end bearing connector 28, with their longitudinally extending axis 74 nonparallel. The longitudinally extending sensor member assemblies 90 extend through the spherical shell segments 46. In this embodiment, four longitudinally extending sensor member assemblies 90 extend through the spherical shell segments 46, with their longitudinally extending axis 74 nonparallel to each other and oriented relative to the rotary wing hub axis of rotation 54. In some embodiments, the method includes providing a load sensing assembly 96.

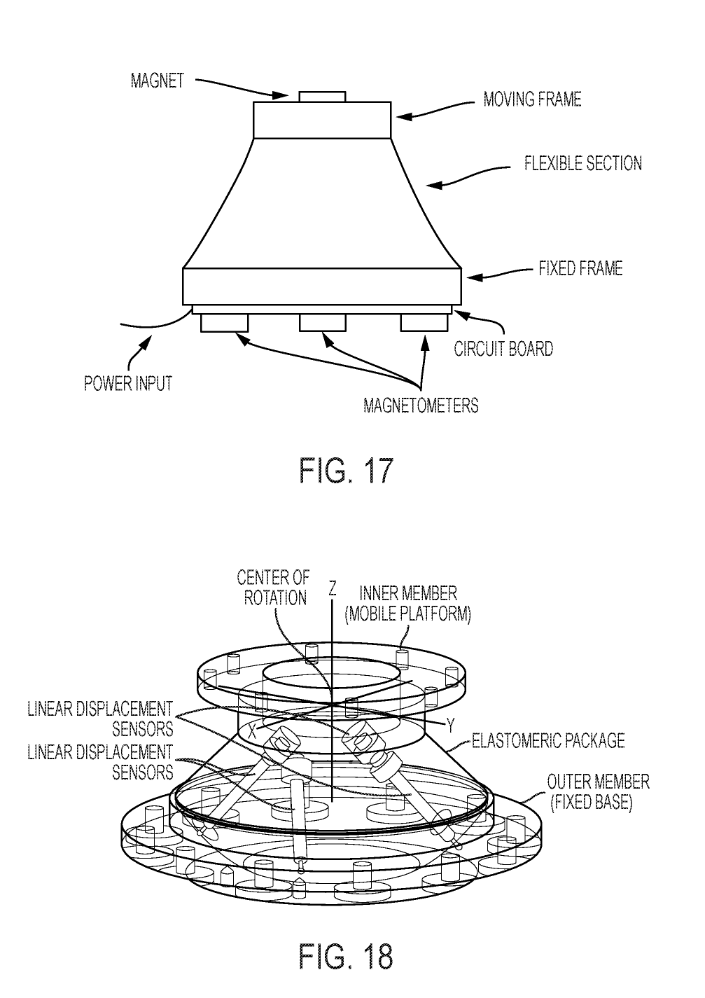

In other embodiments, a FLBC can be configured to accomplish motion sensing in a variety of ways. Referring to FIG. 17, a magnetometer based displacement sensing solution allows the measurement of up to 6 degrees of freedom of motion (x-axis displacement, x-axis rotation, y-axis displacement, y-axis rotation, z-axis displacement, z-axis rotation). This is achieved through the use of an array (3 or more) of 3-axis magnetometers and one or more fixed rare earth magnets. No contact with the measured device is necessary, but the board carrying the magnetometers and the magnets must be in the same frame of reference as the measured device. This allows the application of magnetometer based measurement on almost any component or geometry. Besides magnetometers and magnets, function of the measurement system also requires a power source and data processing. Data processing can either be performed real-time in an embedded processor or off-line through post processing. The data processing consists of a series of matrix transformations. A distinct advantage of this method of measurement is the lack of active circuits on one side of the component. This eliminates the need for power or wiring of any kind to one of the two sides.

Referring to FIG. 18, a linear displacement sensor approach to motion sensing is shown. Four (or more, for higher accuracy) linear displacement sensors are inserted into holes bored through the elastomer and shim layers of a HCL bearing. These sensors are oriented in such a manner and attached to the inner and outer members of the HCL bearing such that motion of one member relative to the other causes a change in sensor lengths. There is no closed form solution for the relationship between sensor displacement and bearing orientation. However, this implementation can be modeled as a parallel mechanism, a device which has a large body of research on various numerical solutions. These include Newton-Raphson, Genetic Algorithms, Neural Networks, and various root finding methods of high-order polynomials. This technology was proven by being implemented on two different LORD HCL bearings: both an S-76 and an UH-60, and undergoing extensive testing.

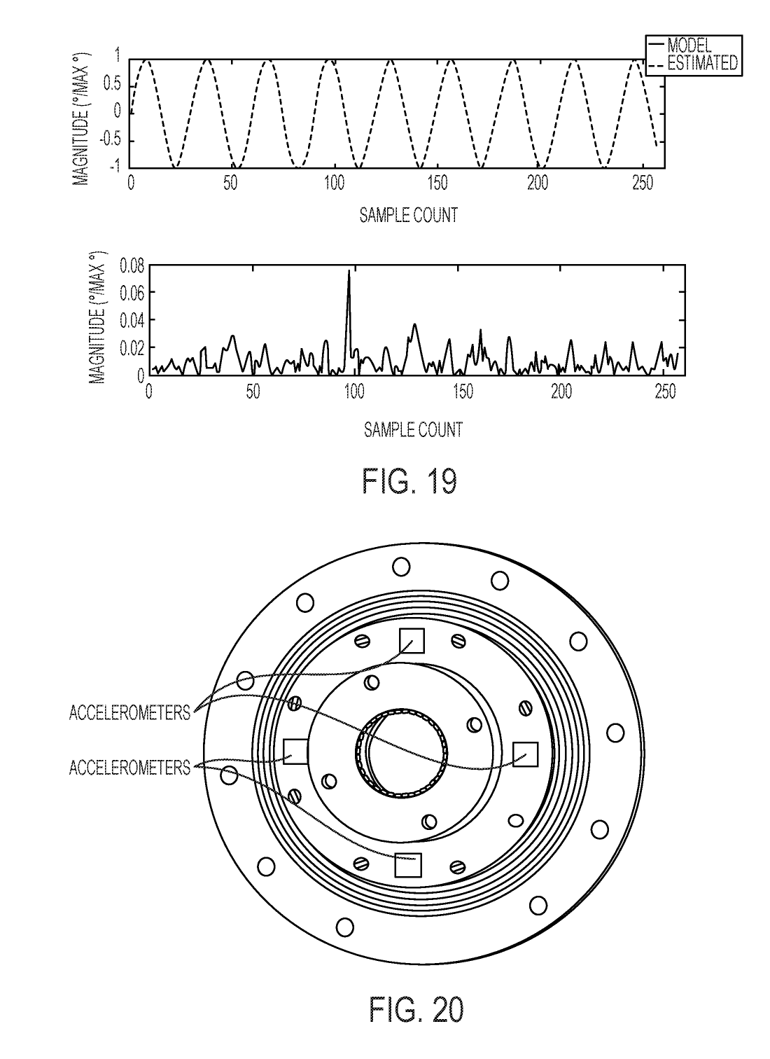

As mentioned above, significant risk reduction testing has occurred with this technology. FIG. 19 shows some results from the risk reduction testing. As shown in FIG. 19, accuracy of this approach is very good, with a cocking angle error of approximately 0.02% in testing.

With regard to conventional electromechanical linear sensors, the sensors can comprise a large number of conventional electromechanical resistors which could be used in this application. The prototype devices referenced in the previous section utilized Differential Variable Reluctance Transducers (DVRT's), which are similar in principle to Linear Variable Displacement Transducers (LVDT's). Below is a non-comprehensive list of possible sensor types: DVRTs, LVDTs, Linear Potentiometers, and Cable extension transducers.

Alternatively a rubbery ruler may be utilized. A rubbery ruler is a material consisting of two coils of wire wound in a double helix configuration surrounded by an elastomer skin. The elastomer tension causes the wire coils to maintain their original shape and return to it after being stretched. Stretching the material causes a gap to form between the coils of the double helix. This small gap between each coil acts similarly to a parallel plate capacitor. If the coil has a voltage on it, increasing the gap size between the coils will cause the voltage to increase and vice versa. Due to the electrostatic nature of the material, this voltage increase produces a small amount of power (˜10's of nanowatts). This phenomenon allows the material to be used as a low power displacement sensor where the voltage change corresponds to a given displacement, e.g. 1 mV/mm.

Some simple tests were performed on a sample of rubbery ruler to determine its response time and accuracy. The material was elongated at integer frequencies from 1 to 10 Hz using an oscillating motor. The response time was good for all frequencies. There are several ways the material could be improved for specific applications. Given a known frequency of displacement and a known level of accuracy needed, the type of metal selected for the coil, the size of wire selected for the coil, the length of the coil, the coil diameter and the elastomer used as a skin could all be adjusted to provide more accurate readings and faster response times.

Alternatively, an EGaIn approach may be utilized. EGaIn is a combination of Gallium and Indium, which has a melting point of 16° C. However, the material also oxidizes nearly instantaneously, which allows it to be poured into any shape desired, then exposed to air. At that point, a skin which is only a few nanometers thick will form around the liquid metal, containing the liquid but still allowing elongation, much like a rubber membrane. Elongating the material at this point causes a strain, which is measurable as a change in resistance in the material. The skin is also elastic, so the material returns to its original shape when strain is removed. These properties would allow the material to be used as a displacement sensor, where a small voltage is used to measure the changing resistance as the material stretches and returns to its initial shape.

One of the largest hurdles to overcome in the use of EGaIn as a displacement sensor is the 16° C. melting point. Below 16° C., the liquid metal would solidify, robbing the material of its elongation properties and usefulness as a displacement sensor. However, this problem could be overcome with some simple solutions, such as insulating the EGaIn by encasing it in an elastomeric membrane, thus insulating it somewhat. In addition, resistive heating could be used to warm the EGaIn by 10's or even 100's of ° C. A calculation demonstrating resistance heating is illustrated in Equation 1:

R×I²=σ·S(T⁴−T₀⁴) Equation 1

Where: R=resistance of EGaIn, I=current through EGaIn, σ=heating constant, S=surface area, T=new temperature of wire, and Tₒ=original temperature of wire.

Using this calculation, a wire of EGaIn 100 microns in diameter with a length of 40 mm, requires only 2 mW to increase in temperature by 8.5° C. Given specific operating conditions, a wire designed to have any temperature rise required for continued functionality with a comparatively small power draw when compared to traditional displacement sensors, requires about 50 mW minimum.

Referring now to FIG. 20 an inertial sensing embodiment is shown. The inertial sensing embodiment refers to an application of MEMS accelerometers and gyroscopes around the mobile portion of the bearing. The MEMS accelerometers are placed in pairs that are 180° apart, but each set of pairs can be placed at any angle relative to the others around the face of this mobile section and oriented so that the measurement axis is perpendicular to the direction of rotation. By then taking the differential between pairs of accelerometers which are 180° opposed, the bearing rotation angles can be estimated using one of the numerical solutions discussed in the linear displacement sensor section. A 3-D CAD model of the sensor orientation on an S-76 HCL bearing assembly is shown in FIG. 20. This method can be utilized in a non-rotating environments, such as for a sub-sea riser tensioner bearing and/or other FLBC.

The mathematical approach to solving for the resultant angles is similar in both situations. The difference between the two is the acceleration magnitude measured, and thus the sensors which should be used. The following discusses the theory behind using this system in the rotational environment.

For a rotary wing aircraft application, the theory behind using static DC measurement accelerometers to determine rotor blade orientation depends on centrifugal force. Centrifugal force is an inertial force that results in a radial acceleration being applied to all objects in a rotating reference frame. The magnitude of acceleration on an object is proportional to that object's radial distance from the axis of rotation and the square of the angular velocity. Therefore, given a known rate of rotation and known distance from the axis of rotation, an expected radial acceleration may be easily calculated. This principle is used to determine the orientation of rotor blades for helicopters by placing accelerometers in carefully selected locations on rotor blade bearing components that LORD already supplies. One example is the spherical bearing for Sikorsky's S-76 helicopter. This bearing transmits all of the flap and lead-lag motion, and approximately 20% of the pitch motion that each rotor blade undergoes during flight. By placing four accelerometers on the flange between the pitch bearing and spherical bearing, they undergo the same angles of motion as the rotor blade. The axis for lead-lag motion and flap motions each need two accelerometers on them, in a symmetric placement about the center of rotation. This is because as the radius of the accelerometer varies compared to the initial position due to bearing articulation, the acceleration magnitude due to centrifugal acceleration will also vary. However, in addition to the change in magnitude of acceleration due to radius change, there will also be a change in the magnitude reported by the accelerometer because of the change in accelerometer angle relative to the acceleration vector. When the centrifugal force is replaced with gravitational force, the methodology will apply the same. It essentially functions as a multi-degree of freedom inclinometer.

A combination of any or all of the above motion sensing approaches, combined with the use of more advanced algorithms, results in a much higher accuracy measurement approach. For example, combining the magnetometer and inertial approaches through a Kalman filtering approach enables the use of algorithms similar to high-accuracy Inertial Measurement Units (IMU's) which are used for various automated navigation tasks.

Additionally, a FLBC can be configured to accomplish load sensing in a variety of ways. A first approach is use of strain gauges. By embedding strain gages in the major metal of an HCL bearing, as demonstrated on an S-76 bearing and UH-60 bearing, the six-degree of freedom of load can be extrapolated. A minimum of six full bridge gages is required (due to six unknowns), but using multiples of six (twelve, eighteen, etc.) allows for averaging between the gages and a higher accuracy in the load estimation. Another approach is pressure measurement. There has been some initial investigation into directly measuring the load on elastomer layers. This could be accomplished in multiple ways including: embedding pressure sensors into the elastomer layers, using conductive elastomer layers, impregnated with carbon black, and measuring the resistance change as the layers are compressed and stretched from bearing motion.

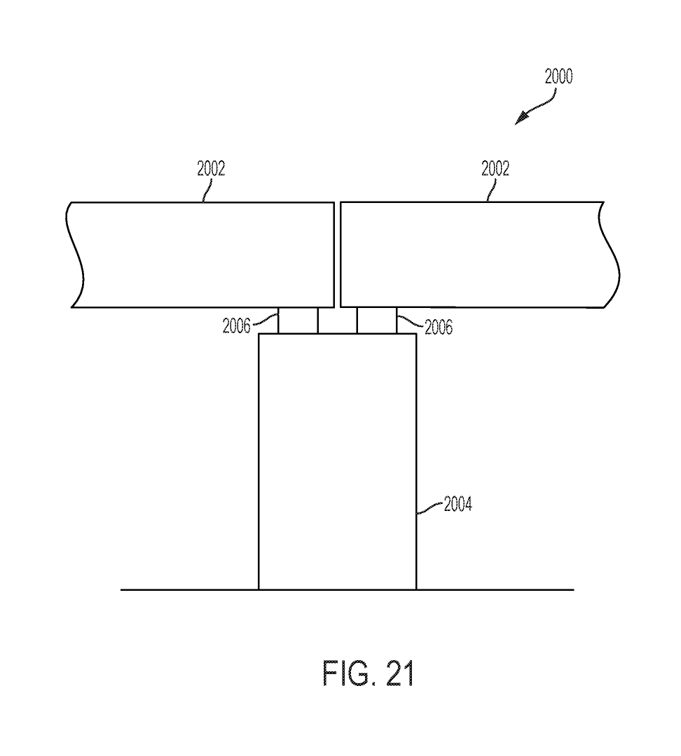

Referring now to FIG. 21, a physical system, namely, a bridge system 2000 is shown as comprising roadway sections 2002 supported by a vertical support 2004. In this embodiment, at least one FLBC 2006 is disposed between each roadway section 2002 and the vertical support 2004 so that the roadway sections 2002. The FLBCs 2006 comprise at least one of a sensor, a processor, and a communication device and may further comprise any of the other components and/or features of other FLBCs and/or motion control bearings disclosed herein. The primary load vector of a bridge system 2000 may be vertically downward and associated with the weight of the bridge system 2000 itself. The FLBCs 2006 can be tuned and/or otherwise configured to withstand, monitor, report, and/or otherwise make use of relatively low frequency vibrations and/or relatively small displacements.

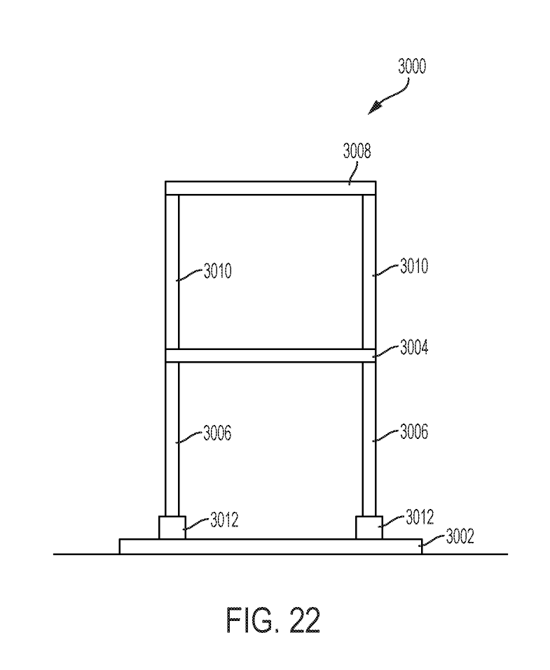

Referring now to FIG. 22, a physical system, namely, a building system 3000 is shown as comprising a foundation 3002, a second floor 3004 supported by vertical supports 3006, a third floor 3008 supported by vertical supports 3010, and at least one FLBC 3012 disposed between the vertical supports 3006 and the foundation 3002. The FLBCs 3012 comprise at least one of a sensor, a processor, and a communication device and may further comprise any other of the components and/or features of other FLBCs and/or motion control bearings disclosed herein. The primary load vector of a building system 3000 may be vertically downward and associated with the weight of the building system 3000 itself. The FLBCs 3012 can be tuned and/or otherwise configured to withstand, monitor, report, and/or otherwise make use of relatively low frequency vibrations and/or relatively small displacements.

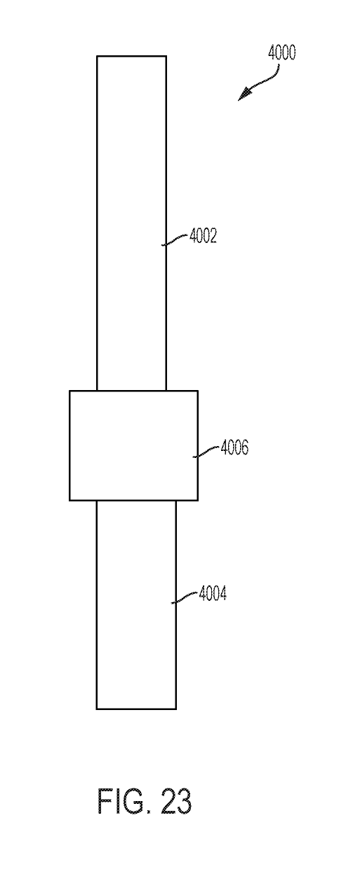

Referring now to FIG. 23, a physical system, namely, a riser system 4000 is shown as comprising a subsea riser 4002 joined to a blowout preventer (BOP) 4004 using an FLBC 4006. The FLBC 4006 comprises at least one of a sensor, a processor, and a communication device and may further comprise any of the components and/or features of other FLBCs and/or motion control bearings disclosed herein. The primary load vector of a riser system 4000 may be generally along the longitudinal length of the riser 4002 and/or vertically downward and associated with the weight of riser system 4000 itself. The 4000 can be tuned and/or otherwise configured to withstand, monitor, report, and/or otherwise make use of relatively low frequency vibrations and/or relatively small displacements, such as, but not limited to displacements and/or vibrations attributable to ocean waves and/or water currents. The load supported by and/or transmitted through the FLBC 4006 can be extremely large, such as, but not limited to, on the order of hundreds of kilopounds.

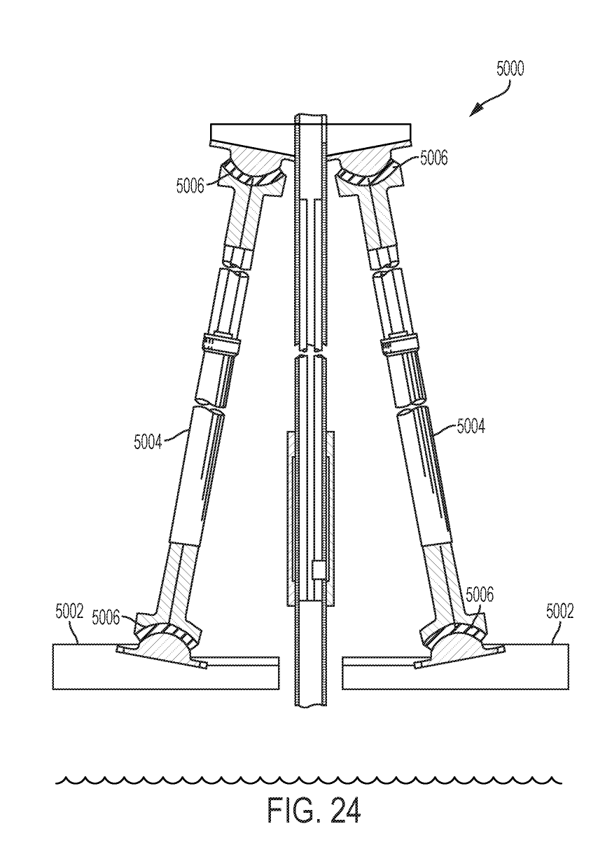

Referring now to FIG. 24, a physical system, namely, a tendon riser system 5000 is shown as comprising a buoyant support 5002, legs 5004, and FLBCs 5006. In this embodiment, the FLBCs 5006 are tendon riser bearings. The FLBCs 5006 comprise at least one of a sensor, a processor, and a communication device and may further comprise any of the components and/or features of other FLBCs and/or motion control bearings disclosed herein. The primary load vector of a riser system 4000 may be generally along the longitudinal length of a tendon 5008 and may increase as a tension on the tendon 5008 is increased. The FLBCs 5006 can be tuned and/or otherwise configured to withstand, monitor, report, and/or otherwise make use of relatively low frequency vibrations and/or relatively small displacements, such as, but not limited to displacements and/or vibrations attributable to ocean waves and/or water currents. The load supported by and/or transmitted through the FLBCs 5006 can be extremely large, such as, but not limited to, on the order of hundreds of kilopounds.

In some embodiments, an FLBC comprises a fully integrated monitoring, processing, and reporting functionality. For example, in some embodiments, an FLBC comprises an onboard computing capability configured to log information and data regarding the present and/or past functioning of the FLBC. The onboard computing of an FLBC may be conducted by a general purpose computer comprising a processor. The onboard computing may further convert traditional engineering outputs such as measurements into actionable information so that later computations are not necessary to make decisions regarding management of the FLBC and/or the physical system to which it is attached. For example, rather than simply outputting displacement measurements, an FLBC may output and/or communicate a message or indication, whether audible, visible, tactile, chemical, etc. that a dangerously large displacement has occurred. In some embodiments, such as in energy production systems, an FLBC may be configured to be compatible with communicating via a communication umbilical.

In some embodiments, an FLBC comprises one or more onboard output devices and/or indicators. For example, an FLBC can be configured to provide communications and/or indications regarding component life information and/or warnings based on performance and/or health of the FLBC and/or environmental exposures the FLBC has sensed and/or endured. The FLBC may further comprise components for forensic data storage. The FLBCs may further be configured to indicate overstress situations where the FLBC is being or has been overstressed. In some cases, optical indications and/or sensors may be utilized to send information from an FLBC or receiving information from an FLBC. In some cases, the optical indications may comprise an FLBC emitting fluorescent and/or color material based on a threshold being overcome and/or gradually over the life of the FLBC. In some cases, optical sensors located onboard the FLBC or remotely, such as through the use of an underwater robot may sense the optical indication and be utilized to manage the FLBC and/or the system to which it is attached.

In some embodiments disclosed herein, one or more of a sensor, a communication device, and a processor are configured to selectively provide data at a normal rate and a relatively higher rate in response to a change in environmental conditions, operational conditions, and/or according to a schedule. For example, sensors, communication devices, and/or processors associated with the above-described systems 1000, 2000, 3000, 4000, and 5000, when operating in association with a body of water and/or when operation is dependent upon weather conditions, can selectively operate at the normal rate under normal water/subsea and/or weather conditions and can selectively operate at the relatively higher rate in abnormal water/subsea and/or weather conditions, such as, but not limited to, storm, tsunamis, earthquakes, and/or other events. In some embodiments, a sensor, communication device, and/or processor can be configured to selectively provide data at a rate at least as low as about 0.5 Hz. In some embodiments, a sensor, communication device, and/or processor can be configured to selectively provide data at a rate within a range of about 0.5 Hz to about 128 Hz. In some embodiments, a sensor, communication device, and/or processor can be configured to selectively provide data at a rate of about 32 Hz. In some embodiments, a sensor, communication device, and/or processor can be configured to selectively provide data at a rate within a range of about 32 Hz to about 5000 Hz. In some embodiments, a sensor, communication device, and/or processor can be configured to selectively provide data at a rate of about 0.5 Hz to about 32 Hz when water/subsea and/or weather conditions are normal and can be further configured to selectively provide data at a rate within a range of about 32 Hz to about 5000 Hz when water/subsea and/or weather conditions are abnormal. In some cases, abnormal water/subsea and/or weather conditions can exist when the forces exerted on the systems 1000, 2000, 3000, 4000, 5000 and/or FLBCs 10, 200, 2006, 3006, 4006, 5006 exceed preset thresholds in force amplitude, force direction, and/or force frequency. For example, a storm may cause changes in both out of water and water/subsea conditions that result in forces being exerted on the systems 1000, 2000, 3000, 4000, 5000 and/or FLBCs 10, 200, 2006, 3006, 4006, 5006 that exceed a preset force amplitude, in a direction that is beyond a preset direction, and/or with variations in the force that occur with a frequency greater than a preset frequency.

In some embodiments disclosed herein, a primary force vector through the FLBC is associated with gravity and is attributable to the weight of the systems to which the FLBC is attached. In some cases, FLBCs may be exposed to sea water, hydrocarbons, and/or any other contaminate, such as, but not limited to when the FLBC is utilized in a riser system 4000.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A system, comprising:
a first component;
a second component;
a bearing stack disposed between the first component and the second component, the bearing stack including:
at least two stacked elastomeric elements; and
at least one non-elastomeric element disposed between the at least two stacked elastomeric elements; and
at least one of a sensor, a communication device, and/or a processor at least partially disposed within the bearing stack;
wherein the bearing stack is configured to support at least about 500 kilopounds.

2. The system of claim 1, wherein the bearing stack is a component of a subsea tension riser system.

3. The system of claim 1, wherein the at least one of the sensor, the communication device, and the processor is fully encapsulated within the bearing stack.

4. The system of claim 1, wherein the at least one of the sensor, the communication device, and the processor is configured to selectively provide data at a normal rate and a relatively higher rate in response to a change in subsea conditions.

5. The system of claim 1, wherein the at least one of the sensor, the communication device, and the processor is configured to selectively provide data at a rate at least as low as about 0.5 Hz.

6. The system of claim 1, wherein the at least one of the sensor, the communication device, and the processor is configured to selectively provide data at a rate within a range of about 0.5 Hz to about 128 Hz.

7. The system of claim 1, wherein the at least one of the sensor, the communication device, and the processor is configured to selectively provide data at a rate of about 32 Hz.

8. The system of claim 1, wherein the at least one of the sensor, the communication device, and the processor is configured to selectively provide data at a rate within a range of about 32 Hz to about 5000 Hz.

9. The system of claim 1, wherein the sensor is selected from the group consisting of: accelerometer sensors, gyroscope sensors, linear variable differential transformer sensors, variable reluctance transducer sensors, linear displacement sensors, displacement transducer sensors, elongating fluid electrical conductor sensors, strain gauge sensors, magnetometer sensors, inertial sensors, magnetic field sensing sensors, force sensors, inertial sensors, moment sensors, linear potentiometer sensors, cable extension transducer sensors, rubbery ruler sensors, microelectromechanical sensors, inclinometer sensors, pressure sensors, optical sensors, and chemical sensors.

10. A system, comprising:
a first component;
a second component;
a bearing stack disposed between the first component and the second component, the bearing stack including:
at least two stacked elastomeric elements; and
at least one non-elastomeric element disposed between the at least two stacked elastomeric elements; and
at least one of a sensor, a communication device, and/or a processor at least partially disposed at least one of the first component and the second component.

11. The system of claim 10, wherein at least one of the sensor, the communication device, and the processor is fully encapsulated within the at least one of the first component and the second component.

12. The system of claim 10, wherein the bearing stack is configured to support at least about 500 kilopounds.

13. The system of claim 10, wherein the bearing stack is a component of a subsea tension riser system.

14. The system of claim 10, wherein the at least one of the sensor, the communication device, and the processor is configured to selectively provide data at a normal rate and a relatively higher rate in response to a change in subsea conditions.

15. The system of claim 10, wherein the at least one of the sensor, the communication device, and the processor is configured to selectively provide data at a rate at least as low as about 0.5 Hz.

16. The system of claim 10, wherein the at least one of the sensor, the communication device, and the processor is configured to selectively provide data at a rate within a range of about 0.5 Hz to about 128 Hz.

17. The system of claim 10, wherein the at least one of the sensor, the communication device, and the processor is configured to selectively provide data at a rate of about 32 Hz.

18. The system of claim 10, wherein the at least one of the sensor, the communication device, and the processor is configured to selectively provide data at a rate within a range of about 32 Hz to about 5000 Hz.

19. The system of claim 10, wherein the sensor is selected from the group consisting of: accelerometer sensors, gyroscope sensors, linear variable differential transformer sensors, variable reluctance transducer sensors, linear displacement sensors, displacement transducer sensors, elongating fluid electrical conductor sensors, strain gauge sensors, magnetometer sensors, inertial sensors, magnetic field sensing sensors, force sensors, inertial sensors, moment sensors, linear potentiometer sensors, cable extension transducer sensors, rubbery ruler sensors, microelectromechanical sensors, inclinometer sensors, pressure sensors, optical sensors, and chemical sensors.

20. A system, comprising:
a first component;
a second component;
a bearing stack disposed between the first component and the second component, the bearing stack including:
at least two stacked elastomeric elements; and
at least one non-elastomeric element disposed between the at least two stacked elastomeric elements; and
at least one of a sensor, a communication device, and/or a processor at least partially disposed within at least one of the first component and the second component;
wherein the bearing stack is configured to support a primary centrifugal force generated during rotation of the bearing stack about a mast of a helicopter.

21. The system of claim 20, wherein the at least one of the sensor, the communication device, and the processor is fully encapsulated within at least one of the first component and the second component.

22. The system of claim 21, wherein the at least one of the sensor, the communication device, and the processor is further embedded within the bearing stack.

23. The system of claim 20, wherein a cocking movement of the bearing stack is associated with a flapping or a feathering of a helicopter rotor blade.

24. The system of claim 20, wherein the at least one of the sensor, the communication device, and the processor is configured to selectively provide data at a rate at least as low as about 0.5 Hz.

25. The system of claim 20, wherein the at least one of the sensor, the communication device, and the processor is configured to selectively provide data at a rate within a range of about 0.5 Hz to about 128 Hz.

26. The system of claim 20, wherein the at least one of the sensor, the communication device, and the processor is configured to selectively provide data at a rate of about 32 Hz.

27. The system of claim 20, wherein the at least one of the sensor, the communication device, and the processor is configured to selectively provide data at a rate within a range of about 32 Hz to about 5000 Hz.

28. The system of claim 20, wherein the sensor is selected from the group consisting of: accelerometer sensors, gyroscope sensors, linear variable differential transformer sensors, variable reluctance transducer sensors, linear displacement sensors, displacement transducer sensors, elongating fluid electrical conductor sensors, strain gauge sensors, magnetometer sensors, inertial sensors, magnetic field sensing sensors, force sensors, inertial sensors, moment sensors, linear potentiometer sensors, cable extension transducer sensors, rubbery ruler sensors, microelectromechanical sensors, inclinometer sensors, pressure sensors, optical sensors, and chemical sensors.
